(19) United States
(12) Patent Application Publication
(10) Pub. No.: US 2021/0064958 A1
(43) Pub. Date: Mar. 4, 2021

(54) HETEROGENEOUSLY INTEGRATED OPTICAL NEURAL NETWORK ACCELERATOR

(71) Applicant: Intel Corporation, Santa Clara, CA (US)

(72) Inventors: Wenhua Lin, Fremont, CA (US); Erik Norden, San Jose, CA (US); Bharadwaj Parthasarathy, San Jose, CA (US); Jin Hong, Saratoga, CA (US); Minnie Ho, Los Altos Hills, CA (US)

(21) Appl. No.: 16/950,824

(22) Filed: Nov. 17, 2020

(51) Int. Cl. G06N 3/04; G06E 1/04; G06E 3/00; G02B 6/28; G06N 3/067

(52) U.S. Cl. CPC G06N 3/04; G06E 1/045; G06N 3/0675; G02B 6/2813; G06E 3/008; G06E 3/005

(57) ABSTRACT

Embodiments of the present disclosure are directed toward techniques and configurations for an optical accelerator including a photonics integrated circuit (PIC) for an optical neural network (ONN). In embodiments, an optical accelerator package includes the PIC and an electronics integrated circuit (EIC) that is heterogeneously integrated into the optical accelerator package to proximally provide pre- and post-processing of optical signal inputs and optical signal outputs provided to and received from an optical matrix multiplier of the PIC. In some embodiments, the EIC is a single EIC or discrete EICs to provide pre- and post-processing of the optical signal inputs and optical signal outputs including optical to electrical and electrical to optical transduction. Other embodiments may be described and/or claimed.

### FIELD

Embodiments of the present disclosure generally relate to the field of optoelectronics and optical neural network processors, and more particularly, to techniques and configurations for providing integrated silicon photonics optical devices.

### BACKGROUND

Artificial neural networks (ANNs) are computing systems vaguely inspired by the brain. Conventional ANNs typically rely on electronic components or architectures based on CMOS-related technology. An optical neural network (ONN) is a physical implementation of an artificial neural network which includes optical components. Applications that may require fast processing of high amounts of data, such as voice recognition, image processing, and search rankings, are fed from a high-performance CPU for processing by the ONN. Recently, ONN accelerators built with discrete optical and electrical components have begun to emerge. Relative to their predecessors, the ONN accelerators can reach higher power efficiency, e.g., more than tens of Tera-Operations/Second per Watt (TOPS/W), faster computation speeds, e.g., clock frequencies higher than 10 Giga-Hertz (GHz), as well as lower latency, e.g. less than 1 nanosecond (ns).

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example top view of a 2×2 unitary directional optical coupler, in accordance with embodiments of the present disclosure.

FIG. 2 illustrates an example top view of a 2×2 unitary adiabatic directional optical coupler, in accordance with embodiments of the present disclosure.

FIG. 3 illustrates an example top view of a plurality of 2×2 unitary directional optical couplers and adiabatic directional optical couplers including one or more common or differential phase shifters, in accordance with embodiments of the present disclosure.

FIG. 4 illustrates a top view of two example 2×2 unitary multi-mode interference (MMI) optical couplers, in accordance with embodiments of the present disclosure.

FIG. 5 illustrates a top view of example 2×2 unitary multi-mode interference (MMI) optical couplers, having one or more of differential phase shifters and/or common phase shifters, in accordance with embodiments of the present disclosure.

FIGS. 6A-6F illustrate top views and cross-sectional views of 2×2 unitary directional optical couplers, in accordance with embodiments of the present disclosure.

FIGS. 7A-7C illustrate top views and cross-sectional views of a 2×2 unitary MMI optical coupler, in accordance with embodiments of the present disclosure.

FIGS. 8A-8C illustrate top views and cross-sectional views of a 2×2 unitary MMI optical coupler, in accordance with another embodiment of the present disclosure.

FIG. 9 illustrates a matrix multiplier that includes a plurality of 2×2 unitary directional optical matrices and an optical unitary matrix that includes a plurality of 2×2 unitary multi-mode interference (MMI) optical couplers, in accordance with other embodiments of the present disclosure.

FIG. 10 is a context diagram that shows a nonlinear optical device within a layer of an ONN, in accordance with various embodiments of the present disclosure.

FIG. 11 is a block diagram of an overview of a photonics integrated circuit (PIC) and electronic support circuitry, in accordance with embodiments of the present disclosure.

FIG. 12A is a block diagram of a photonics integrated circuit (PIC) and electronic support circuitry similar to that of FIG. 11, in accordance with embodiments of the present disclosure.

FIG. 12B is a side view of the PIC of FIG. 12A with a plurality of discrete EIC dies that integrate one or more elements of the electronic support circuitry, in accordance with embodiments of the present disclosure.

FIG. 13 is a side view of a PIC vertically stacked over a single integrated EIC, in accordance with embodiments of the present disclosure.

FIG. 14 is a side view of a PIC and a CPU on a similar substrate, vertically stacked over a single integrated EIC, in accordance with embodiments of the present disclosure.

FIG. 15 is a side view of another embodiment of a PIC and a CPU on a similar substrate, vertically stacked over a single integrated EIC, in accordance with embodiments of the present disclosure.

FIG. 16 is a side view of a single integrated EIC stacked over a PIC, in accordance with embodiments of the present disclosure.

FIG. 17 illustrates an example computing device that may include the PIC and/or CPU of FIGS. 11-16, in accordance with various embodiments.

### DETAILED DESCRIPTION

Embodiments of the present disclosure describe techniques and configurations for an apparatus for an optical neural network (ONN). In embodiments, the apparatus includes e.g., a heterogeneously integrated optical accelerator including a stacked photonics integrated circuit (PIC) and an electronics integrated circuit (EIC). In embodiments, the PIC includes an ONN having one or more layers of optical unitary matrix multipliers and an optical nonlinearity function implemented via nonlinear optical devices. In embodiments, the EIC is stacked in a manner vertically above or below the PIC in a single optical accelerator package with the PIC to proximally provide pre- and post-processing of optical signal inputs and optical signal outputs including optical to electrical and electrical to optical transduction. Integration of the EIC into the optical accelerator package as described may result in higher bandwidth, higher density and lower power consumption due to a proximal location of radiofrequency (RF) interfaces of the PIC and EIC.

In embodiments, the optical signal inputs and optical signal outputs are provided by the optical accelerator to (and received from) a CPU, such as, e.g., a server CPU (e.g., Intel XEON™ or other high performance CPU). In some embodiments, the optical accelerator is considered a co-processor to the CPU, which may be located on a motherboard external to the optical accelerator package. In other embodiments, the CPU is integrated in the optical accelerator package with the PIC and the EIC. In some embodiments, the EIC is a single integrated EIC including some or substantially all functions required for pre-and post-processing of data provided between the PIC die and the CPU. In some embodiments, the EIC includes a plurality of integrated EICs or discrete EIC dies that integrate single or multiple functions of the same. In embodiments, the optical unitary matrix multiplier comprises a plurality of 2×2 unitary optical matrices optically interconnected, and each 2×2 unitary optical matrix comprises a plurality of phase shifters to phase shift, split, or combine one or more of the optical signal inputs.

In the following description, various aspects of the illustrative implementations will be described using terms commonly employed by those skilled in the art to convey the substance of their work to others skilled in the art. However, it will be apparent to those skilled in the art that embodiments of the present disclosure may be practiced with only some of the described aspects. For purposes of explanation, specific numbers, materials, and configurations are set forth in order to provide a thorough understanding of the illustrative implementations. It will be apparent to one skilled in the art that embodiments of the present disclosure may be practiced without the specific details. In other instances, well-known features are omitted or simplified in order not to obscure the illustrative implementations.

In the following detailed description, reference is made to the accompanying drawings that form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous. The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or more elements are in direct contact.

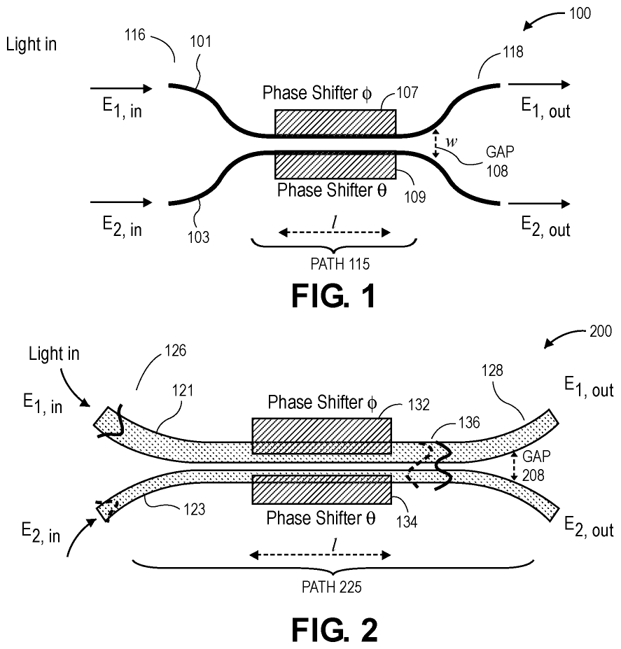

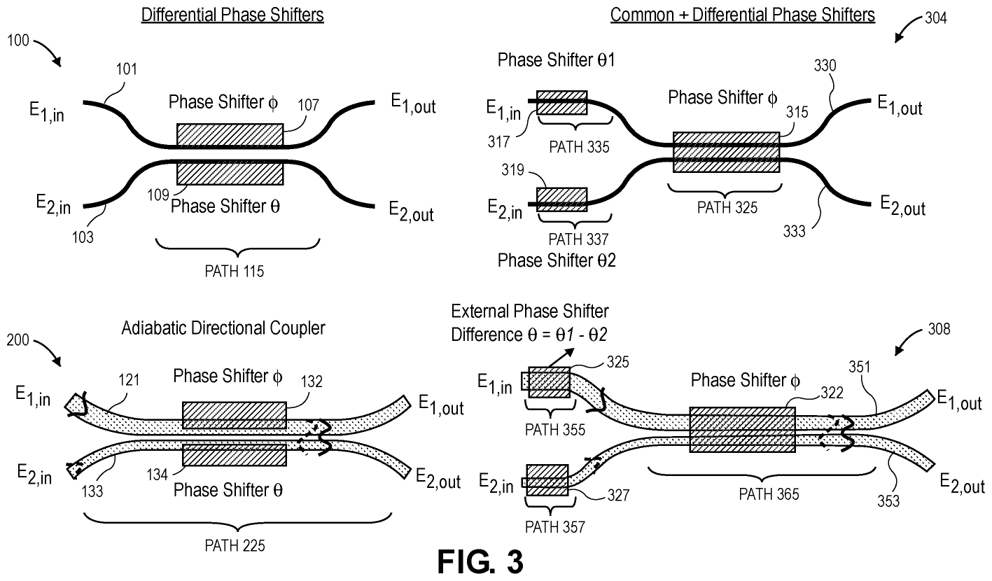

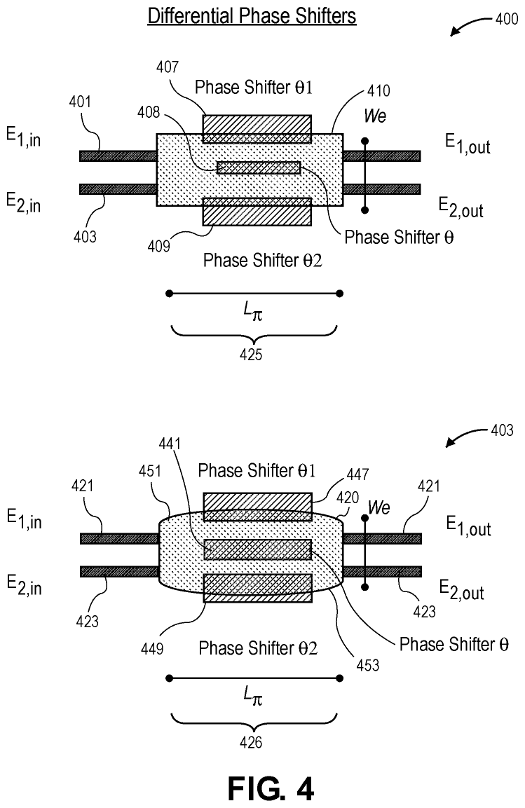

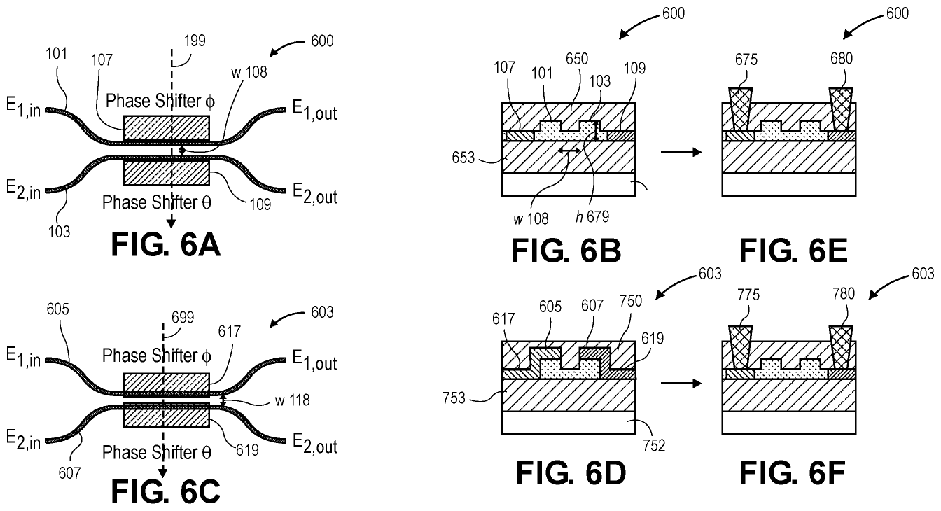

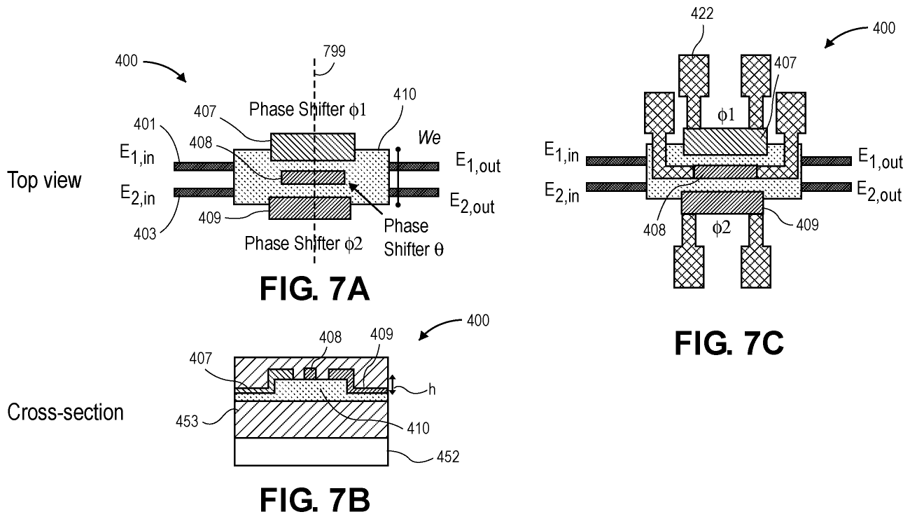

As noted above, stacked photonics integrated circuit (PIC) of the optical accelerator includes a plurality of 2×2 unitary optical matrices optically interconnected. In embodiments these 2×2 unitary optical matrices include 2×2 unitary directional optical couplers and 2×2 unitary MMI optical couplers are described and shown in connection with FIGS. 1-9 below. For example, in various embodiments, the matrix multipliers include a plurality of 2×2 unitary adiabatic directional optical couplers such as the 2×2 unitary adiabatic directional optical coupler of FIG. 2, 2×2 unitary directional optical couplers and adiabatic directional optical couplers having one or more common or differential phase shifters of FIG. 3, or 2×2 unitary multi-mode interference (MMI) optical couplers having one or more of differential phase shifters and/or common phase shifters of FIG. 5. Note that FIGS. 6-8 illustrate side views and cross-sectional views of various embodiments of the devices introduced in FIGS. 1-5.

FIG. 1 is illustrates an example top view of a 2×2 unitary directional optical coupler 100 (also referred to as “directional optical coupler 100”), in accordance with embodiments. In embodiments, a configuration of directional optical coupler 100 allows for a 2×2 optical unitary matrix multiplier that is able to perform a 2×2 unitary linear transformation on optical signals in a limited or compact space. As shown, directional optical coupler 100 includes a first optical waveguide 101 and a second optical waveguide 103. First optical waveguide 101 and second optical waveguide 103 are coupled to form a 2×2 optical unitary matrix to receive a respective first input optical signal (e.g., E_{1, in}) and a second input optical signal (e.g., E_{2, in}). As seen from FIG. 1, optical waveguide 101 and 103 form a respective first arm and a second arm that diverge at a first end (e.g., 116) and a second end (e.g., 118) and converge along a middle portion of a path (e.g., path 115). In embodiments, path 115 runs along first optical waveguide 101 and second optical waveguide 103 in a substantially parallel manner. In the embodiment, path 115 includes or integrates a plurality of phase shifters, (e.g., phase shifter 107 and phase shifter 109) to assist in transforming the first optical signal or the second optical signal into a first output optical signal (e.g., E_{1 out}) and second output optical signal (e.g., E_{2 out}) to be output from the 2×2 optical unitary matrix. In embodiments, the transformation includes a combining, splitting, and phase shifting of the first input optical signal and the second input optical signal.

As will be discussed further, in embodiments, phase shifters 107 and 109 include at least one of an electro-optical induced index modulator, thermal-optics induced index modulator, image-spot modulator, or opto-electronic-mechanical modulator, to allow for tunable power at output waveguides. In the embodiment shown, phase shifter 107 applies a first phase shift ø and phase shifter 109 applies a second phase shift Θ. As noted previously, in embodiments, directional optical coupler 100 performs a linear unitary transformation via matrix multiplication to input optical signals E_{1,in} and E_{2, in}. For example, the transfer matrix for the directional optical coupler of FIG. 1 can be expressed as:

$$U ( 2 ) = ( \frac{cos ( θ - ∅ )}{i sin ( θ - ∅ )} \frac{i sin ( θ - ∅ )}{cos ( θ - ∅ )} )$$

Note that in embodiments, path 115 has a length of or includes a critical coupling length, l, to allow the unitary transformation of optical signals in optical waveguide 101 and 103. Thus, in the embodiment, 2×2 unitary directional optical coupler 100 includes phase shifters 107 and 109, which may also serve as optical splitters and optical combiners integrated along the critical coupling length l, to respectively split or combine the first input optical signal and/or second input optical signal. In embodiments, critical coupling length l is determined to be a length to, in combination with a width of gap 108, promote or allow the first optical signal to switch from first optical waveguide 101 to the second optical waveguide 103 or vice-versa. Thus, tuning of one or more of the phase shifters causes the first input optical signal or the second input optical signal (or a portion thereof) to be switched into either of the arms to effectively form an analog switch.

As noted above in FIG. 1, optical waveguide 101 and 103 form a respective first arm and a second arm that diverge at a first end (e.g., 116) and a second end (e.g., 118) and converge along a middle portion of a path (e.g., path 115). In embodiments, path 115 is a substantially parallel path along first optical waveguide 101 and second optical waveguide 103. Furthermore, note that path 115 includes a gap 108, having a width w, which runs between first optical waveguide 101 and second optical waveguide 103 along the substantially parallel path. In embodiments, the configuration of the 2×2 optical unitary matrix including the first arm and the second arm that converge to at least a critical coupling length l and gap 108 allow for the matrix multiplication to be performed in a limited or compact space.

Referring now to the embodiment of FIG. 2, which illustrates an example top view of a 2×2 unitary adiabatic directional optical coupler 200 (also sometimes referred to as “adiabatic directional coupler”). In FIG. 2, adiabatic directional optical coupler 200 includes a first optical waveguide 121 and second optical waveguide 123 evanescently coupled to form a 2×2 optical unitary matrix. In embodiments, adiabatic directional optical coupler 200, however, is formed to operate without optical loss or substantially any optical loss. In the embodiments shown, adiabatic directional optical coupler 200 is formed to include optical waveguides that have dissimilar widths, core dimensions, or bend diameters, from each other and/or that vary in their widths or diameters along a length of an optical path that includes a plurality of phase shifters, e.g., phase shifter 132 and 134. In the embodiment, adiabatic directional optical coupler 200 receives a respective first input optical signal (e.g., E_{1,in}) and a second input optical signal (e.g., E_{2, in}) and outputs a respective first output optical signal (e.g., E_{1 out}) and second output optical signal (e.g., E_{2 out}). As shown, optical waveguide 121 and optical waveguide 123 converge to run alongside each other to direct the first input optical signal and the second input optical signal along optical path 225 (“path 225”). In embodiments, path 225 may include a critical coupling length, l, that may be longer or shorter than path 225, but that promotes adiabatic evanescent coupling between optical signals in optical waveguide 121 and 123.

As noted above and as shown in FIG. 2, first optical waveguide 121 has a different width, core dimension, or bend diameter, from second optical waveguide 123. Furthermore, in some embodiments, the width of one or more of first optical waveguide 121 and second optical waveguide 123 varies along path 225. Accordingly, adiabatic directional optical coupler 200 includes a first optical waveguide 121 separated from a second optical waveguide 123 by a gap 208. In embodiments, gap 208 varies in width along path 225 due to varying width of first optical waveguide 121 or second optical waveguide 123. In embodiments, gap 208 includes a width that in addition to a critical coupling length l, is determined to promote evanescent coupling (e.g., at 136) between a first input optical signal and second input optical in first optical waveguide 121 and second optical waveguide 123.

As seen in FIG. 2, optical waveguides 121 and 123 form a respective first arm and a second arm that diverge at a first end (e.g., 126) and a second end (e.g., 128) and converge along a middle portion of a substantially parallel path (e.g., path 225). Note optical waveguides 121 and 123 form a concave up or concave down shape. Note that as shown and discussed in connection with FIGS. 3 and 6 below, it is understood that a type and number of phase shifters in directional optical coupler 100 and adiabatic directional optical coupler 200 will vary.

FIG. 3 illustrates an example top view of a plurality of 2×2 unitary directional optical couplers and adiabatic directional optical couplers including one or more common or differential phase shifters, in accordance with embodiments. On a left side of FIG. 3, directional coupler 100 and adiabatic directional coupler 200 as described above in FIGS. 1 and 2 are reproduced. Note that directional coupler 100 and adiabatic directional coupler 200 include differential phase shifters. For example, unitary directional optical coupler 100 includes phase shifter 107, which applies a phase shift ø, and phase shifter 109, which applies a phase shift Θ, to apply a differential phase shift (e.g., phase shift ø−phase shift Θ). Similarly, adiabatic directional coupler 200 includes phase shifters 132 and phase shifter 134 to apply a differential phase shift (phase shift ø−phase shift Θ) to a first input optical signal (e.g., E_{1,in}) and a second input optical signal (e.g., E_{2, in}) of adiabatic directional coupler 200.

In contrast, directional optical coupler 304 and adiabatic directional optical coupler 308 on a right side of FIG. 3 include both differential phase shifters and a common or single phase shifter that is common to both optical waveguides. As shown, directional optical coupler 304 includes a first optical waveguide 330 and a second optical waveguide 333. Common phase shifter 315 is located or integrated on a path common to each of first optical waveguide 330 and second optical waveguide 333. In contrast, external phase shifters 317 and 319 are located on paths 335 and 337 that are external to a path 325 that integrates common phase shifter 315, which implements a unitary transformation of the 2×2 unitary matrix. In the example embodiment, external phase shifters 317 and 319 of directional optical coupler 304 together apply a differential phase shift of phase shift Θ1−phase shift Θ2.

Similarly, in embodiments, adiabatic directional coupler 308 includes a first optical waveguide 351 and a second optical waveguide 353 including a common phase shifter 322. Common phase shifter 322 is located or integrated on a path common to each of first optical waveguide 351 and second optical waveguide 353. In contrast, external phase shifters 325 and 327 are located on paths 355 and 357 that are external to a path 365 that integrates common phase shifter 322, which implements a unitary transformation. In embodiments, external phase shifter 325 applies phase shift Θ1 while external phase shifter 327 applies a phase shift of Θ2 to together apply a differential phase shift of Θ1−Θ2.

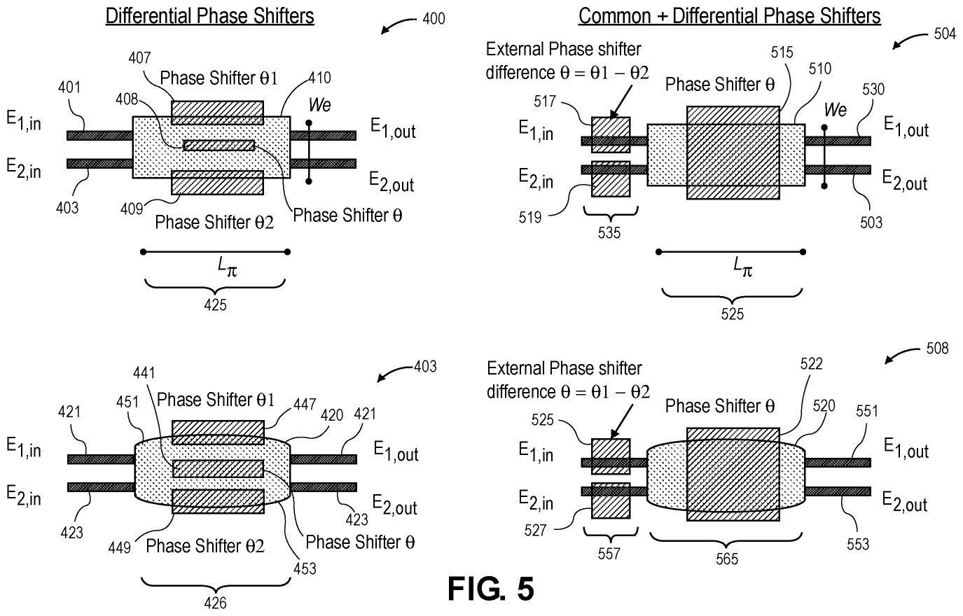

Referring now to FIG. 4, which illustrates a top view of two example 2×2 unitary multi-mode interference (MMI) optical couplers, in accordance with embodiments. In FIG. 4, each of unitary MMI optical coupler 400 and a unitary MMI optical coupler 403 include respective multi-mode (MMI) waveguide structures 410 and 420 that intersect an optical path. In embodiments, the MMI waveguide structures are formed such that modes of a first optical signal and modes of a second optical signal interfere with each other to assist in performing a unitary transformation of input optical signals. Note that unitary MMI optical coupler 400 and unitary MMI optical coupler 403 are similar to each other, with the exception of a differing shape of a bowed shape of MMI waveguide structure 420 of unitary MMI optical coupler 403.

As shown, unitary MMI optical coupler 400 includes a first optical waveguide 401 and a second optical waveguide 403 coupled to form a 2×2 optical unitary matrix to receive a respective first input optical signal (e.g., E_{1 in}) and a second input optical signal (e.g., E_{2 in}). In embodiments, MMI waveguide structure 407 has a length Lπ and a width Wₑ. Optical waveguide 401 and optical waveguide 403 run alongside each other to direct the first input optical signal and the second input optical signal along an optical path 425 that intersects with MMI waveguide structure 410 for length Lπ. In the embodiment, optical path 425 includes or integrates a plurality of phase shifters to assist in performing a unitary transformation of the first optical signal and/or the second optical signal into a first output optical signal (e.g., E₁ₒᵤₜ) and second output optical signal (e.g., E_{2 out}). In the embodiment, MMI optical coupler 400 includes phase shifter 407, phase shifter 408, and phase shifter 409 along length Lπ.

Similarly, unitary MMI optical coupler 403 includes a first optical waveguide 421 and a second optical waveguide 423 coupled to form a 2×2 optical unitary matrix to receive a respective first input optical signal (e.g., E_{1 in}) and a second input optical signal (e.g., E_{2 in}). In the embodiment, optical path 426 includes or integrates a plurality of phase shifters to assist in performing a unitary transformation of the first optical signal or the second optical signal into a first output optical signal (e.g., E₁ₒᵤₜ) and second output optical signal (e.g., E₂ₒᵤₜ) to be output from the 2×2 optical unitary matrix. In the embodiment, MMI optical coupler 403 includes phase shifter 447, phase shifter 441, and phase shifter 449 along length Lπ.

In embodiments, MMI waveguide structure 420 has a length Lπ and a width Wₑ. Optical waveguide 421 and optical waveguide 423 run alongside each other to direct the first input optical signal and the second input optical signal along an optical path 426 that intersects with MMI waveguide structure 420 for length Lπ. As noted above, MMI waveguide structure 420 has a differing shape than MMI waveguide structure 410. In the embodiment shown, MMI waveguide structure 420 has a curved or bowed shape along lengthwise perimeters 451 and 453. In embodiments, the curved or bowed shape provides additional space to allow interference of the modes of the first optical input signal and a second optical input signal.

Note that, in embodiments, length Lπ of MMI optical couplers 400 and 403 includes a fraction or a multiple of a critical beating length Lc of the two lowest order modes, with a multiple of a phase shifter combination for optimal phase shift efficiency. For example, if width Wₑ is a width of MMI optical couplers 400 or 403, βo is the propagation foundation of the foundational mode, β1 is the propagation constant of a first order mode, nᵣ is the effective refractive index of an optical waveguide, e.g., MMI waveguide structure 407 or 420, and λo is the wavelength of the light, then:

Note that, although MMI optical coupler 400 and 403 each include three phase shifters, it is understood that in other embodiments, the MMI optical couplers include any suitable number of phase shifters or arrangements of phase shifters to phase shift the first input optical signal and/or the second input optical signal to perform a unitary transformation. In some examples, MIMI optical couplers includes successive phase shifters along the optical path that includes length Lπ. In some examples, the MMI optical couplers also include a combination of both common phase shifters and differential phase shifters as will be shown in FIG. 5. In embodiments, modes of the first optical signal and the second optical signal interfere in the MM waveguide to output an optical signal at a power ratio that can be adjusted according to unitary matrix algebra.

FIG. 5 illustrates a top view of example 2×2 unitary multi-mode interference (MMI) optical couplers, having differential phase shifters and/or common phase shifters. Unitary MMI optical couplers 400 and 403 of FIG. 4, whose elements were shown and described in connection with FIG. 4, are reproduced on a left column of FIG. 4. Thus, unitary MMI optical coupler 400 includes phase shifter 407 and phase shifter 409 to apply a differential phase shift (e.g., phase shift ø1−phase shift ø2). Similarly, MMI optical coupler 403, having curved MMI waveguide structure 420, includes phase shifters 447 and 449 to apply a differential phase shift (phase shift ø1−phase shift ø2) on its respective first optical waveguide and second optical waveguide. Each of MMI optical coupler 400 and 403 also include respective phase shifters 408 and 441 to apply a phase shift Θ.

Unitary MMI optical couplers 504 and 508 on a right side of FIG. 5 include elements similar to or the same as unitary MMI optical couplers 400 and 403. In contrast to unitary MMI optical couplers 400 and 403, however, unitary MMI optical couplers 504 and 508 have differential phase shifters located external to their respective waveguide structures 510 and 520. In embodiments, the differential phase shifters are located or integrated on an external path (e.g., 535 and 557) optically coupled to the respective 2×2 unitary matrices. Unitary MMI optical couplers 504 and 508 each include a common phase shifter integrated within or on waveguide structures 510 and 520. In embodiments, common phase shifters 515 and 522 are located in or integrated on substantially an entire optical path along respective waveguide structures 510 and 520. In contrast, external phase shifters (517, 519 and 525, 527) are located on paths 535 and 537 that are external to optical paths 525 and 565 of respective waveguide structures 510 and 520. Note that, in embodiments, due to having both common and differential phase shifters, unitary directional optical coupler 100 may be tuned with differential and common phase control modes.

FIGS. 6-8 illustrate top and cross-sectional views of various embodiments of example 2×2 unitary directional optical couplers and 2×2 unitary MMI optical couplers. Note that in embodiments, the optical couplers are formed in crystalline silicon. Examples of waveguide materials include but are not limited to silicon, a thin silicon layer in SOI (silicon on insulator), glass, oxides, nitrides, e.g., silicon nitride, polymers, semiconductors or other suitable materials. In embodiments, waveguides in the optical couplers described in the FIGS. may be made of any medium that propagates a wavelength of light and surrounded with a cladding with a lower index of refraction. In some embodiments, waveguides may be formed on a buried oxide layer (BOX) layer of an SOI wafer with a top cladding layer over the waveguides. In embodiments, the top cladding layer includes silicon dioxide (SiO₂) having an index of refraction of n=1.45, while a silicon-based waveguide has an index of refraction of, e.g., n=3.48. In embodiments, the optical couplers are formed via known lithography/etch methods associated with formation of optical waveguides on SOI wafers.

FIGS. 6A-6F illustrate top and cross-sectional views of example 2×2 unitary directional optical couplers, in accordance with embodiments of the present disclosure. FIG. 6A illustrates unitary directional optical coupler 600 which is the same or similar as unitary directional optical coupler 100 shown and described in FIG. 1 (for brevity, description of some similar elements are not repeated). In embodiments, a dotted arrow 199 represents a plane through which a cross-section of unitary directional optical coupler 600 is shown in FIG. 6B. As shown, in FIG. 6B, first optical waveguide 101 and second optical waveguide 103 are single mode optical waveguide structures formed over a buried oxide layer (BOX) 653 on a silicon on insulator (SOI) wafer 652. In the embodiment, a top cladding layer 650 is formed over first optical waveguide 101 and second optical waveguide 103. In the embodiment, phase shifter 107 and phase shifter 109 are formed to abut or nearly abut respective first optical waveguide 101 and second optical waveguide 103 but do not cover first optical waveguide 101 and second optical waveguide 103. In embodiments, an example width w of a gap 108 between waveguides 101 and 103 is 0.2-0.8 micrometers (μm). In the example of FIG. 6A, first optical waveguide 101 and second optical waveguide 103 have heights of 0.2-0.4 μm (e.g., element 679 in FIG. 6B). Note that these widths and heights are only examples and any suitable heights or widths that are consistent with providing 2×2 unitary directional optical couplers with phase shifters to perform the unitary transformation are contemplated.

In some embodiments, after formation of phase shifters 107 and 109, metal connections to control a tuning of the phase shifters using known methods are implemented. For example, various method include, but are not limited to, processes that include, e.g., resistive thin-film strip (doped silicon, SiN) or metal wire (TiW, Tungsten) as thermal phase shifters, or doped P+ regions and doped N+ regions to form p-i-n junctions as electro-optical phase shifters. For example, FIG. 6E illustrates unitary directional optical coupler 600 after metal connections 675 and 680 are formed (note that similar or same elements have not been labeled for clarity in the FIGS), using known methods such as passivation layer (typical oxide layer, SiN) deposition, and pad openings for metal contacts and connections 675 and 680. In various embodiments, metal connections 675 and 680 may include wire bonding, bump pads, or other suitable connections, coupled to allow a tenability of phase shifters 107 and 109. In embodiments, electro-optic tuning of phase shifters 107 and 109 control application of weights being applied in matrix multiplication in the unitary transformation.

In an embodiment, shown in FIG. 6C, is another unitary directional optical coupler 603. As shown, unitary directional optical coupler 603 includes a phase shifter 617 and phase shifter 619 that cover at least a top portion of first optical waveguide and a second optical waveguide 605 and 607. In embodiments, a dotted arrow 699 represents a plane through which a cross-section of unitary directional optical coupler 603 is shown to the right of optical coupler 603 in FIG. 6D. As shown, phase shifters 617 and 619 are formed over a buried oxide layer (BOX) 753 over a silicon on insulator (SOI) wafer 752. A top cladding layer 750 is shown above phase shifters 617 and 619. As noted above, phase shifters 617 and 619 are formed to cover at least a portion of respective first optical waveguide 605 and second optical waveguide 607.

After formation of phase shifters 617 and 619, metal connections to control a tuning of the phase shifters are formed. For example, FIG. 6F illustrates unitary directional optical coupler 603 after metal connections 775 and 780 are formed (note that similar or same elements have not been labeled for clarity in the FIGS). In various embodiments, metal connections 775 and 780 may include wire bonding, bump pads, or other suitable connections, to allow a tunability of phase shifters 617 and 619.

In embodiments, phase shifter 107 and phase shifter 109 of FIG. 6A are PN-diode-based phase shifters or thermal based phase shifters. Note that in other embodiments, phase shifters 617 and 619 of FIG. 6C may cover varying portions of first optical waveguide 605 and second optical waveguide 607.

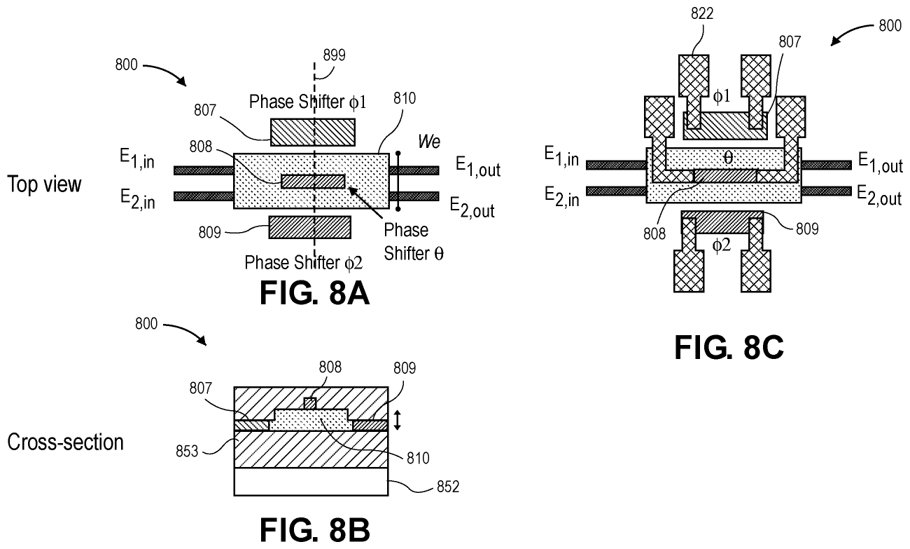

FIGS. 7A-7C illustrate top and cross-sectional views of a 2×2 unitary MMI optical coupler, in accordance with embodiments of the present disclosure. FIGS. 7A-7C illustrate embodiments associated with methods of forming phase shifters of a unitary MMI optical coupler. FIG. 7A illustrates a unitary MMI optical coupler similar to as shown and described in FIG. 4 (note that description of similar elements may not be repeated). In embodiments a dotted arrow 799 represents a plane through which a cross-section of unitary MMI optical coupler 400 is shown in FIG. 7B. As seen in FIG. 7B, unitary MMI optical coupler 400 is formed over a buried oxide layer (BOX) 453 on a silicon on insulator (SOI) wafer 452. In embodiments, phase shifters 407 and 409 are formed to cover at least a portion of MMI waveguide structure 410. In some embodiments, MMI waveguide structure 410 is a waveguide that is wide compared to, e.g., first optical waveguide 401 and second optical waveguide 403, and includes a width Wₑ of, for example, 2-10 μm and a height h of 0.2-0.4 μm. In the embodiment, additional phase shifter 408 is formed over (or integrated above) MMI waveguide structure 410. After formation of the phase shifters, metal connections to control a tuning of the phase shifters are formed. For example, FIG. 7C illustrates MMI optical coupler 400 after metal connections 422 are formed. In various embodiments, metal connections 422 may include wire bonding or bump pads coupled to tunable phase shifters of MMI optical coupler 400. Although six metal connections are shown, only metal connection 422 is labeled for clarity in the FIGS.

Note that an electro-optical tuning applied through the metal connections allows the modes of the first optical signal and the second optical signal to interfere in the MM waveguide to output an optical signal at a power ratio that can be adjusted according to U(2) matrix algebra.

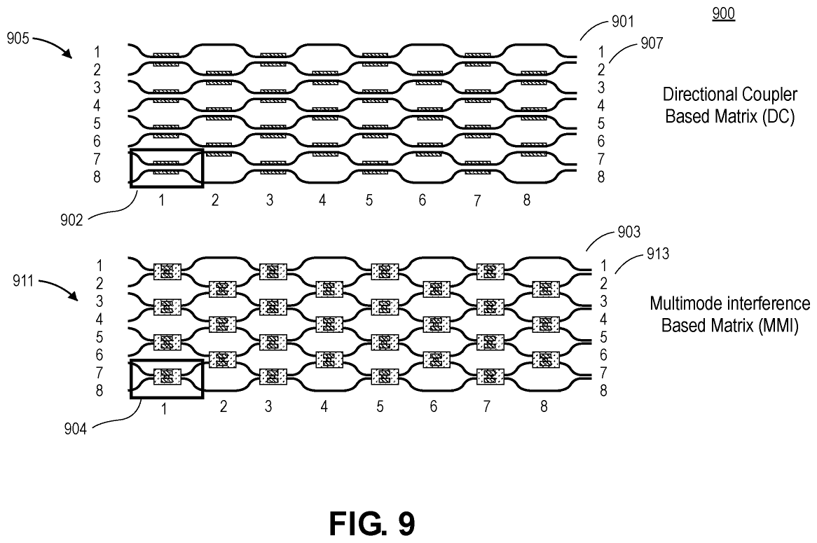

FIGS. 8A-8C illustrate top views and cross-sectional views of another 2×2 unitary MMI optical coupler, in accordance with another embodiment of the present disclosure. FIGS. 8A-8C are associated with a method of forming phase shifters in a unitary MMI optical coupler. FIG. 8A shows a top view of a unitary MMI optical coupler similar to that of FIGS. 7A-7C and FIG. 4, with the exception that a first and a second phase shifter are formed next to MMI waveguide structure 810 (rather than covering a portion of MMI waveguide structure 810). In FIG. 8A, a dotted arrow 899 represents a plane through which a cross-section of a unitary MMI optical coupler 800 is shown in FIG. 8B. As seen in FIG. 8B, unitary MMI optical coupler 800 is formed over a buried oxide layer (BOX) 853 on a silicon on insulator (SOI) wafer 852. In embodiments, phase shifters 807 and 809 are formed next to MMI waveguide structure 810. In the embodiment shown, a third, or additional, phase shifter 808 is formed over (or integrated above) MMI waveguide structure 810.

After formation of the phase shifters, metal connections to control a tuning of the phase shifters 807 and 809 are formed. For example, FIG. 8C illustrates unitary MMI optical coupler 800 after metal connections 822 are formed. In various embodiments, metal connections 822 may include wire bonding or bump pads coupled to tunable phase shifters 807, 808, and 809 of MMI optical coupler 800. Although six metal connections are shown, only metal connection 822 is labeled for clarity in the FIGS.

Note that phase shifters 407, 409 and 807, 808, and 809 of FIGS. 7A and 8A may include any suitable type of phase shifter such as, but not limited to, PN-junction diode phase shifters or thermal heater phase shifters. Furthermore, as noted previously, a number and configuration of phase shifters may vary. For example, in various embodiments, a plurality of phase shifters may be integrated on MMI waveguide structure 410 or 810 in a successive arrangement (not shown).

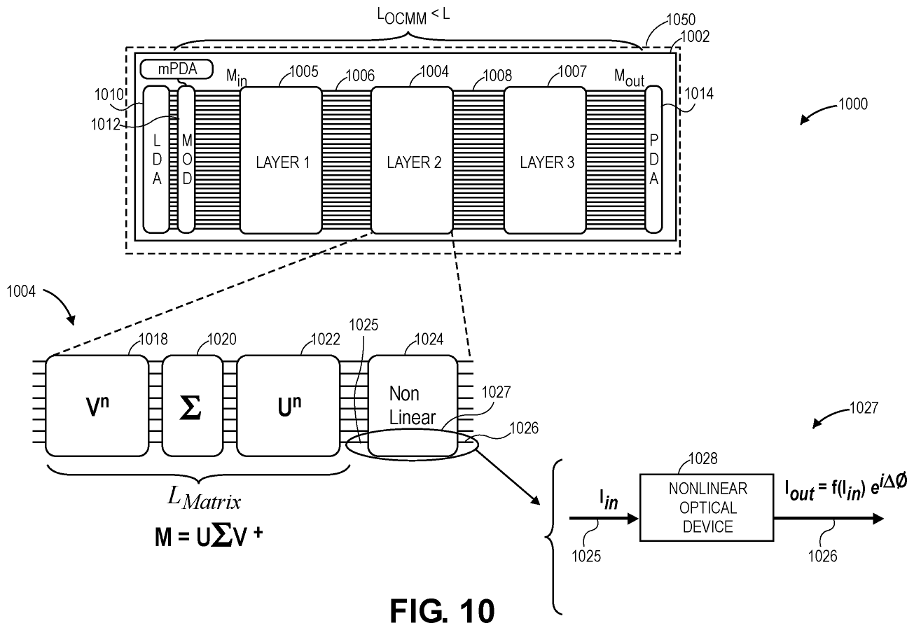

FIG. 9 illustrates examples of a first matrix multiplier and a second matrix multiplier having a plurality of optical unitary matrices coupled together. In embodiments, the unitary optical matrices are coupled together to form matrix multipliers having a plurality of n optical inputs and a plurality of n optical outputs. In embodiments, the plurality of 2×2 unitary optical matrices are optically coupled to receive an array of optical signal inputs and to linearly transform the plurality of optical signal inputs into an array of optical signal outputs, wherein each of the plurality of 2×2 unitary optical matrices include a first optical waveguide and a second optical waveguide coupled to converge and diverge along an optical path.

In embodiments, matrix multiplier 901 is a larger unitary optical matrix that includes a plurality of 2×2 unitary directional optical matrices 902 (e.g., similar or the same as directional optical coupler 100 of FIG. 1), while matrix multiplier 903 includes a plurality of 2×2 unitary multi-mode interference (MIMI) optical couplers 904 (e.g., similar or the same as the example 2×2 unitary (MMI) optical couplers of FIG. 4). Note that for clarity in the FIG., only one of 2×2 directional optical matrices 902 (e.g., 2×2 directional optical coupler 100 of FIG. 1) and one of 2×2 unitary MMI optical couplers 904 is labeled. For matrix multiplier 901, a plurality of 2×2 directional optical matrices 902 are optically coupled together to receive an array of optical signal inputs at 905 in FIG. 8 and to linearly transform the plurality of optical signal inputs into an array of optical signal outputs 907. Similarly, for matrix multiplier 903, a plurality of unitary MMI optical couplers 904 are coupled together to receive an array of optical signal inputs at 911 to linearly transform the plurality of optical signal inputs into an array of optical signal outputs 913.

Note that in various embodiments, the matrix multipliers include any of, or any suitable combination of, different types of 2×2 optical matrices, such as the 2×2 unitary directional optical couplers and 2×2 unitary MMI optical couplers as described and shown in previous FIGS. 1-8. For example, in various embodiments, the matrix multipliers include a plurality of 2×2 unitary adiabatic directional optical couplers such as the 2×2 unitary adiabatic directional optical coupler of FIG. 2, 2×2 unitary directional optical couplers and adiabatic directional optical couplers having one or more common or differential phase shifters of FIG. 3, or 2×2 unitary multi-mode interference (MMI) optical couplers having one or more of differential phase shifters and/or common phase shifters of FIG. 5.

Note that the array of optical signal inputs 905 for matrix multiplier 901 (and optical signal inputs 911 for matrix multiplier 903) include n optical inputs and n optical signal outputs where n=8. In embodiments, the matrix multipliers each include n (n−1)/2 2×2 unitary optical matrices (e.g., n (n−1)/2 2×2 optical matrices). Although n=8 in FIG. 9 for both matrix multiplier 901 and 903, it should be understood that 8 is only an example and n is any number of optical inputs and optical outputs suitable for an application. In embodiments, n is 2, 4, 8, 16, 32, 64, 128, or 256. It is further understood that couplings as in matrix multiplier 901 and 903 have been simplified in order to conceptually illustrate optical connections between 2×2 directional optical matrices 902 or unitary multi-mode interference (MMI) optical couplers 904. The matrix multiplier can have n optical inputs and m output outputs, n may be not equal to m where n, m=2, 3, 8, 16, 32, 64, 128 or 256, and the matrix multiplier includes n (m−1)/2 2×2 unitary optical matrices.

Accordingly, as described in connection with FIGS. 2-8, each of 2×2 directional optical matrices 902 and 2×2 unitary multi-mode interference (MMI) optical couplers 904 each include a first optical waveguide and a second optical waveguide coupled along an optical path. Furthermore, for the embodiments, a plurality of tunable optical phase shifters (e.g., as described in connection with FIGS. 1-8) are included along the optical path of each of the first optical waveguide and the second optical waveguide in each of the plurality of 2×2 unitary optical matrices to phase shift an optical beam to linearly transform the array of optical signal inputs into the array of optical signal outputs.

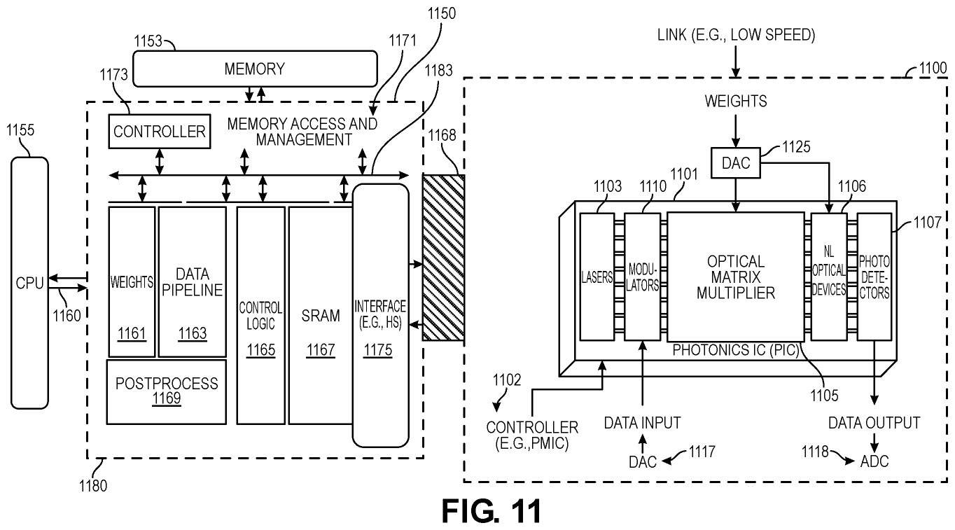

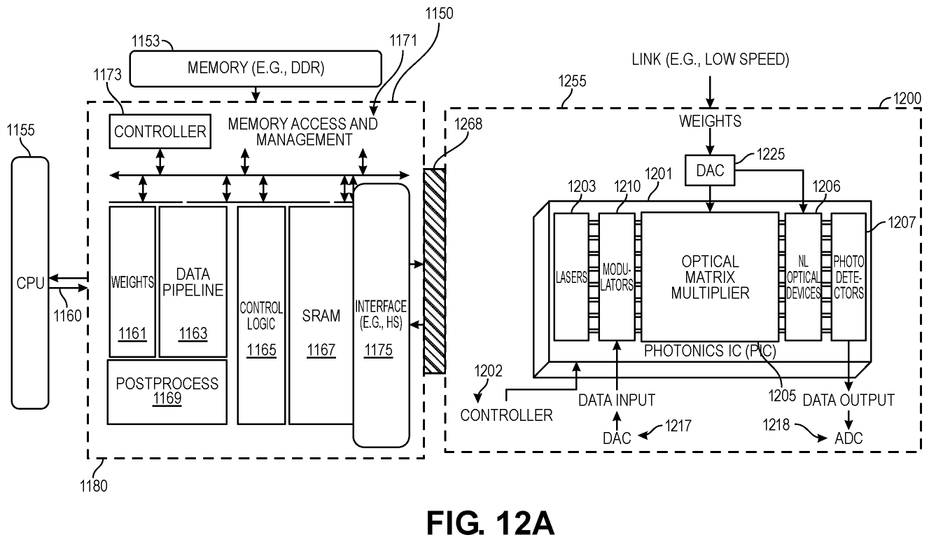

FIG. 10 is a context diagram that shows a nonlinear optical device within a layer of an ONN included on a photonics integrated circuit (PIC) that will be discussed in connection with FIGS. 11-17, in accordance with various embodiments. In embodiments, the ONN includes one or more layers each including a plurality of optical unitary matrix multipliers followed by optical nonlinear optical devices implementing a nonlinearity function. Integrated photonic device 100 shows an ONN 1002 that includes one or more layers 1004 having multiple optical signal inputs 1006 and multiple optical signal outputs 1008. In this example, each layer 1004 has 32 optical signal inputs 1006 and 32 optical signal outputs 1008. In other embodiments the number of optical signal inputs 1006 or optical signal outputs 1008 may vary. In embodiments, the ONN 1002 may be provided as an integrated circuit on the integrated photonic device 1000.

Within the ONN 1002, a laser diode array (LDA) 1010 together with optical modulators 1012 (hereinafter referred to as “modulator 1012”) provides optical input to a first layer 1005. A photodetector array 1014 will receive optical output from the third layer 1007, and convert that output into digital signals. In this example, light signals are sent from layer 1 1005, to layer 2 1004, and then to layer 3 1007. Each layer is made up of an optical unitary matrix multiplier (that may include a plurality of optical unitary matrix multipliers) and non-linear optical devices (e.g., nonlinear optical amplifiers 1024 described below). In embodiments, the ONN 1002 including array (LDA) 1010, modulator 1012, multiple layers 1005, 1004, 1007, and PDA 1014 can be implemented in a heterogeneously integrated photonics circuit, such as a single silicon photonics die or single semiconductor substrate 1050.

Diagram 1004a shows various components of the optical unitary matrix multiplier unit within layer 2 1004, which includes three optical unitary matrix multipliers 1018, 1020, 122 that are composed of a plurality of optical unitary matrices (e.g., matrix multipliers including 2×2 unitary directional optical couplers and/or 2×2 unitary MMI optical couplers as described and shown in previous FIGS. 1-9). As shown, the light signals flow out of the Uⁿ optical unitary matrix multiplier 1022 and into a plurality of nonlinear optical devices 1024 for each layer 1004.

Nonlinear optical amplifiers 1024 may be needed to be coupled to the optical unitary matrix multiplier 1022 due to the linear nature of the optical signal processing from the optical unitary matrix multipliers 1018, 1020, 1022. The optical signal, including noise added to the optical signal, may be linearly increased during operation of the ONN 1002, and may result in a final signal intensity from the Uⁿ optical unitary matrix multiplier 1022 that is too high. This signal intensity may cause optical inputs to overload a subsequent layer 1007, or overload the PDA 1014.

The nonlinear optical amplifier 1024 may comprise multiple nonlinear optical devices. An example nonlinear optical device 1028 is shown in FIG. 10 to the right of the layer 1004 (blown-up area 1027 of the nonlinear amplifier 1024). An optical input signal 1025 into the device 1028 may be transformed into an optical output signal 1026 of a particular nonlinear optical device 1028 shown with respect to area 1027. The term “amplifier” is used in a broad sense here. The input signal 1025 may need to be amplified in a linear way, amplified in a non-linear way, as well as saturated and attenuated, and/or otherwise “cleaned up” in order for the resulting optical signal output 1026 to be more distinguishable. Other functions may include light rectifying and saturating for the resulting optical signal output for high classification and predication in the ONN layers. These functions are explained further in reference to FIG. 2.

he equation I out=f(Iᵢₙ)e^{iΔϕ}on the output of 1026 shown in FIG. 10 defines the overall optical signal input to optical signal output nonlinear activation function, where f is the optical intensity function of nonlinear optical device 1028 as a function of optical signal input power Iᵢₙ; and Δϕ is the phase change from optical signal input to optical signal output generated by the non-linear optical device 1028. The intensity function f includes optical amplifying, saturating, rectifying and attenuating, and/or a combination of these functions, or any types of similar function to serve as optical input to optical output nonlinear activation functions. In embodiments, a few criteria are to be met with respect to nonlinear optical device 1028. First, the optical nonlinear activation may need active feedback control to emulate the arbitrary layers matrices and to classify and predict performance. Examples of active control are bias current, voltage and/or phase tuning operation for activation functions in optical amplifying, attenuating and saturating. Second, low electrical power consumption in each optical nonlinear device is typically determined by the biasing current times the biasing voltage applied on the nonlinear optical device 1028, and it is desired to reach power efficiency in ONNs. Third, various optical nonlinear functions f can be implemented in the optical domain with associated IC driver and firmware algorithms, similar to various CMOS IC-based nonlinear functions.

For example, if the signal output 1026 level represents 8 bits, it may be desirable for the nonlinear optical device 1028 to clean up the representation of a low bit to 0, and a high bit to be put into the upper limits as a saturation function. This will enhance the performance of optical signal output to proceed to the next layer in the linear functions of the various optical matrix multipliers.

In embodiments, the nonlinear optical devices provide optical amplification to compensate for waveguide propagation loss needed to emulate the multiple layers of the ONN. In embodiments, a III-V gain medium is bonded to silicon photonics to provide amplification, where the gain medium has both linear and nonlinear amplification functions when input power reaches a saturation level. The amplification function may include a multi-quantum well medium to increase efficiency. In embodiments, a carrier-injection pin diode can be added to couple with the amplification function to provide light attenuation control to not overload the subsequent layer or photodiode array (PDA).

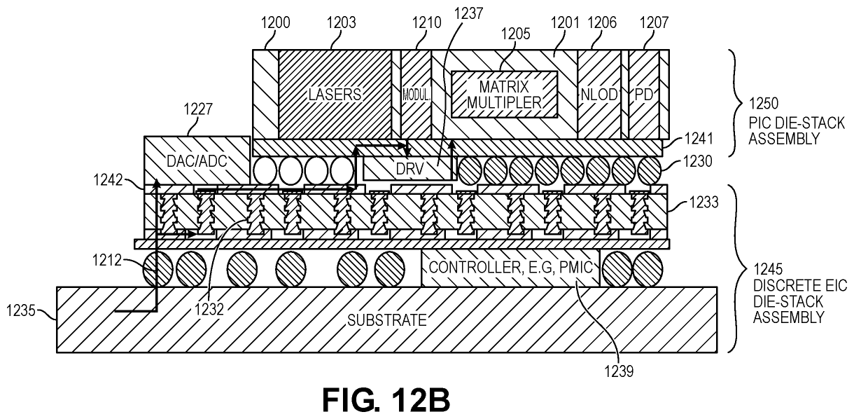

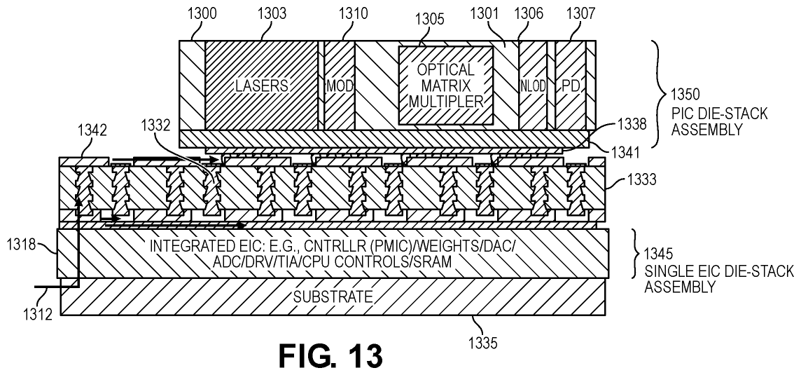

FIG. 11 is a block diagram of an overview of an electronic circuitry 1150 and an integrated photonics device or photonics integrated circuit (PIC) 1100. In embodiments, some or all functions of electronic circuitry 1150 are integrated together into a single EIC die (e.g., FIGS. 13-16) or in different combinations as discrete EIC dies with PIC 1100 (e.g., FIG. 12B) in an optical accelerator package. In embodiments, the single EIC die or discrete EIC dies will assist in supporting data loading and offloading from an optical matrix multiplier of PIC 1100. In embodiments, the PIC is included on a single semiconductor substrate and includes at least an optical unitary matrix multiplier, an array of light sources, and an array of optical modulators and an array of photodetectors integrated in the single semiconductor substrate. In embodiments, the PIC, the array of light sources, e.g., hybrid lasers, and other optoelectronic components are integrated into the single semiconductor substrate.

Referring now to PIC 1100, which includes an optical matrix multiplier 1105 and an array of light sources, such as, e.g., lasers 1103 in a semiconductor substrate, e.g., silicon substrate 1101, to generate an array of light signals or optical signals. In embodiments, lasers 1103 includes any suitable light source such as, e.g., lasers or hybrid lasers (e.g., hybrid bonded lasers on a silicon photonics chip including silicon substrate 1101) such as indium phosphide (InP) lasers. PIC 1100 further includes an array or plurality of optical modulators 1110 coupled to lasers 1103 to receive the array of optical signals. The optical modulator 1110 converts the electrical data into modulated optical signals to generate an array of optical signal inputs. In various embodiments, optical modulators may be Mach-Zehnder interferometers, optical ring modulators, or other suitable high-speed optical modulators. In embodiments, after modulation, optical modulators 1110 provide a plurality of optical signal inputs to optical matrix multiplier 1105 integrated in silicon substrate 1101. As shown in connection with, e.g., FIG. 9, optical unitary matrix multiplier 1105 includes a plurality of 2×2 unitary optical matrices optically interconnected. In the embodiment, optical unitary matrix multiplier 1105 performs matrix multiplication to linearly transform optical signal inputs into an array or plurality of optical signal outputs.

As shown in FIG. 11, PIC 1100 also includes an array or plurality of photodetectors 1107 (“photodetectors 1107”) such as, e.g., waveguide photodetectors, avalanche photodetectors, coupled to detect the optical signal outputs. Non-linear optical devices 1106 (e.g., similar to as shown and described in connection with FIG. 10) are coupled to amplify or attenuate optical signal outputs prior to being detected by photodetectors 1107, which convert the optical signal outputs to photocurrent. In embodiments, electronic amplifiers such as transimpedance amplifiers (TIA) (not shown) are coupled to photodetectors 1107 to receive photocurrent from photodetectors 1107 to further amplify the electrical signal outputs.

Electronic circuitry 1150 is coupled to PIC 1100 via radiofrequency (RF) and direct current (DC) routing interconnections 1168 (e.g., an interconnect bridge or other multi-die interconnection structure). Electronic circuitry 1150 includes weights 1161, a data pipeline 1163, control logic 1165, post-processing unit 1169, a memory (e.g., SRAM) 1167, and a high-speed interface 1175. In embodiments, memory access and management units 1171 and a controller 1173 for CPU control are included in electronic circuitry 1150. In some embodiments, memory access and management units 1171 includes e.g., a Direct Memory Access unit (DMA) and/or a memory management unit (MMU). In embodiments, memory access and management units 1171 transfer data to and from memory 1153 and/or data pipeline 1163 (e.g., activation buffers and the data included in data pipeline 1163) as needed.

CPU 1155 is coupled to electronic circuitry 1150 via a high speed input/output (I/O) bus 1160 (e.g., the latest generation of Peripheral Component Interconnect Express (PCIe) or other high-speed bus). In embodiments, memory 1153 (e.g., Double Data Rate Synchronous Dynamic Random-Access Memory (DDR SDRAM)) provides weights (e.g., initial training weights, staged weights, reuse weights) as well as instructions to be implemented by control logic 1165. In embodiments, memory 1153 is coupled to provide a digital-to-analog converter circuitry (DAC) 1125 with weights for optical matrix multiplier 1105 via a relatively low speed link. In embodiments, data incoming from CPU 1155 (e.g., data values associated with applications, e.g., speech recognition, computer vision, multimedia, and the any suitable machine learning application) to be analyzed by an inference or predictive model of an ONN is provided by CPU 1155 via I/O bus 1160 to join data pipeline 1163. In embodiments, data pipeline 1163 provides a DAC 1117 with real-time data or data input via interface 1175 that is to be input to optical matrix multiplier 1105 via optical modulators 1110.

In embodiments, for an N×M matrix of optical matrix multiplier 1105, optical modulators 1110 encode an N-dimensional input vector (“vector”) of values, x₁, x₂, . . . x_{N}, into the array of optical signal inputs. Optical matrix multiplier 1105 then applies the weights input by DAC 1125 to perform matrix multiplication, resulting in a transformation on the optical signals. Optical matrix multiplier 1105 then provides optical output signals to non-linear optical devices (amplifiers and/or attenuators) 1106 for non-linear transformation. In embodiments, photodetectors 1107 then detect the optical signal outputs and convert the optical signal outputs to photocurrent, which is amplified by transimpedance amplifiers (TIA), and then sent to analog-to-digital converter (ADC) circuitry 1118.

Accordingly, in embodiments, the ADC circuitry (indicated at ADC 1118) converts the optical signal outputs (“outputs”) to electrical signals as real time data that are returned via a high speed link to electronic circuitry 1150. In embodiments, the outputs may be provided to data pipeline 1163, undergo post-processing at post process 1169, and returned to CPU 1155 or SRAM 1167 for next steps. In embodiments, e.g., during a training model in a learning stage of an ONN application, where weights are being updated, the cycle may be repeated until weighted output errors associated with a set of data (such as training data) are sufficiently reduced.

FIG. 12A illustrates a top view of the functional block diagram of electronic circuitry 1150 of FIG. 11 and a photonics integrated circuit (PIC) 1200. PIC 1200 is similar or the same as PIC 1100 of FIG. 11, however, in PIC 1200 is coupled with a plurality of discrete electronic integrated circuit (EIC) dies that integrate one or more elements of electronic circuitry 1150. In the embodiment of FIG. 12B, PIC 1200 is a single flip-chip PIC stacked or proximally located to the plurality of discrete EIC dies. In embodiments, the plurality of discrete EIC dies are stacked proximally to PIC 1200 to provide pre- and post-processing of optical signal inputs and optical signal outputs including optical to electrical and electrical to optical transduction. Note that PIC 1200 and PIC 1100 of FIG. 11 include similar elements, and the descriptions of certain elements are repeated only as necessary below.

In the embodiment of FIG. 12B, a PIC die-stack assembly 1250 is located on top of a discrete EIC die-stack assembly 1245 of a single optical accelerator package. In the embodiment, PIC 1200 is disposed on a redistribution layer 1241 (redistribution layer 1241 includes, e.g., a silicon substrate, silicon interposer, or the like). In FIG. 12B, the plurality of discrete EIC dies include a DAC/ADC die 1227, a laser driver and optical modulator driver die 1237, and a controller die 1239. In embodiments, DAC/ADC die 1227 also includes weights (e.g., weights that can be sent via a weight buffer that reads/writes to/from an SRAM on the EIC or PIC which connects to a DDR memory interface) to be provided to optical matrix multiplier 1205. As shown, in the present configuration, controller die 1239 is disposed on a package substrate, e.g., optical accelerator package substrate 1235 (“substrate 1235”) and below a coupling structure, e.g., a silicon interposer 1233. As seen in FIG. 12B, silicon interposer 1233 includes vias 1232 which connect to connection pads 1242 or bumps 1230. Note that only one connection pad, connector, bump or via, may be labeled in the FIG. for clarity. In embodiments, the connection pads, connectors, bumps, or vias assist in providing connections equivalent to RF/DC routing connections 1168 of FIGS. 11 and 12A.

Integration of the discrete EICs into the optical accelerator package as described may provide higher bandwidth, higher density and lower power consumption due to a proximal location of radiofrequency (RF) interfaces of the PIC and EIC. Note that in embodiments, as an example, input data from CPU 1155 follows a path 1212 to DAC/ADC die 1227. In embodiments, after DAC/ADC die 1227 converts the input data from digital to analog format, it is received by laser driver and optical modulator driver die 1237 to be modulated into optical signal inputs for optical matrix multiplier 1205. In the embodiment of FIG. 12A, controller die 1239 receives instructions from CPU 1155 to be implemented by PIC 1200 as well as performs, e.g., performance management integrated circuit (PMIC) functions. In some embodiments, controller die 1239 controls drivers included in e.g. laser driver and optical modulator driver die 1237. In other embodiments, controls for the lasers and the optical modulators are located in DAC/ADC die 1227. In embodiments, an output path (not shown) of output data from PIC 1100 between and the plurality of discrete EIC dies may follow a path moving downwards from PIC 1200 and form a closed loop within the optical accelerator package.

Note that the configuration of the plurality of discrete EIC dies in relation to PIC 1200 shown in FIG. 12B are merely examples. In other embodiments, for example, DAC/ADC die 1227, laser driver and optical modulator driver die 1237, and controller die 1239, are disposed at any relative location to PIC 1200 that facilitate pre- and post-processing of optical signal inputs and optical signal outputs and including optical to electrical and electrical to optical transduction Furthermore, the functions of each of the plurality of discrete EIC dies may be combined with one or more other functions of the other discrete dies or those not discussed herein but that assist in the pre-and post-processing of the optical signal inputs and optical signal outputs.

Referring now to FIG. 13 which is a side view of an embodiment of a PIC 1300 (similar to PIC 100 of FIG. 11) vertically stacked over a single integrated EIC. In embodiments, a single integrated EIC 1318 integrates some or substantially all elements of electronic circuitry, e.g., electronic circuitry 1150 of FIG. 11. In the embodiment of FIG. 13, PIC 1300 is a single flip-chip PIC (of a PIC die-stack assembly 1350) on top of single integrated EIC 1318 (of a single EIC die-stack assembly 1340) which integrates some or substantially all elements of electronic circuitry 1150. Note that PIC 1300 includes the same or similar elements as PIC 1100, e.g. an array of light sources or lasers 1303 coupled to plurality of optical modulators 1310 (“optical modulators 1310”), which provide modulated optical signal inputs to an optical matrix multiplier 1305 integrated in silicon substrate 1301. PIC 1300 also includes non-linear (NL) optical devices 1306 and photodetectors 1307. In the embodiment, PIC 1300 is disposed on a redistribution layer 1341 (redistribution layer 1341 includes, e.g., a silicon substrate, silicon interposer, or the like) which is connected via connectors 1338 to pads 1342 and vias 1332 of silicon interposer 1333. Note that only one connector, pad, and via, may be labeled in the FIG. for clarity. As shown, single integrated EIC 1318 is disposed between package substrate 1335 and silicon interposer 1333.

As shown, in embodiments, input data from a CPU, e.g., CPU 1155 of FIG. 11, follows a path 1312 to single integrated EIC die 1318 and ultimately to PIC 1300. In the embodiment single integrated EIC die 1318 includes e.g., some or substantially all functions of electronic circuitry 1150 of FIG. 11. In embodiments, pre- and post-processing of optical signal inputs and optical signal outputs includes at least, electro-optical and opto-electrical conversion of data provided to and received from the PIC. In various embodiments, single integrated EIC die 1318 includes DAC circuitry (e.g., to perform functions similar to as described in connection with DAC 1117 and 1125 of FIG. 11) and ADC circuitry (e.g., to perform functions similar to as described in connection with ADC 1118 of FIG. 11), laser and optical modulator drivers (e.g., to perform functions similar to as described in connection with ADC 1118 of FIG. 11), control for laser and optical modulator drivers (to perform functions similar to as described in connection with (PMIC) controller 1102 or ADC 1118 and DAC 1117/1125 of FIG. 11), CPU control circuitry, memory (e.g., SRAM 1167 of FIG. 11) for storage of weights and CPU instruction.

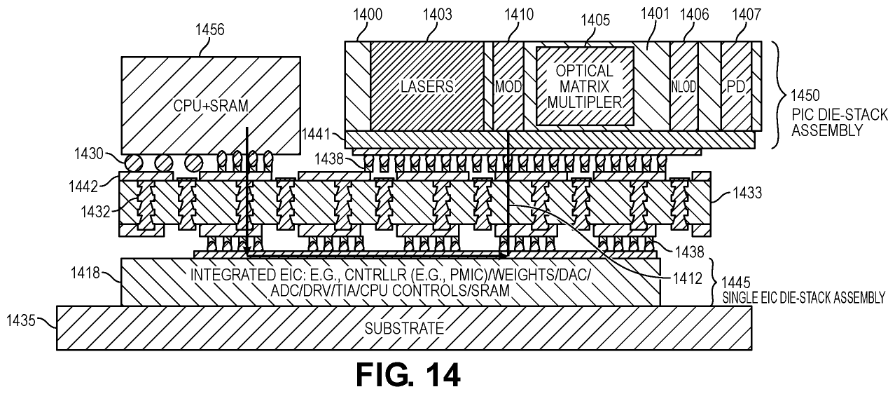

Referring now to FIG. 14 which is a side view of an embodiment of a PIC (similar to PIC 1100 of FIG. 11) and a CPU on a similar substrate vertically stacked over a single integrated EIC. The configuration is similar to that of FIG. 13, with the exception of the CPU including an SRAM memory (to perform functions similar to CPU 1155 of FIG. 11) included on a common substrate with PIC 1400. In embodiments a single integrated EIC 1418 integrates some or substantially all elements of electronic circuitry, e.g., electronic circuitry 1150 of FIG. 11. In the embodiment of FIG. 14, PIC 1400 is a single flip-chip PIC (see PIC die-stack assembly 1450) vertically stacked above single integrated EIC 1418 (of single EIC die-stack assembly 1450) which integrates some or substantially all elements of electronic circuitry 1150 of FIG. 11. As shown in the FIG., a CPU and SRAM combination 1456 is located on a common substrate 1435 with PIC 1400. In embodiments, the CPU is a flip-chip CPU that performs functions similar to CPU 1155 of FIG. 11. In some embodiments, SRAM and/or CPU and SRAM combination includes memory in a chiplet or high-efficiency (angular division multiplexing (ADM) memory chiplets or RAMBO™ memory chiplet format.

Note that PIC 1400 includes the same or similar elements as PIC 1100 of FIG. 11, e.g. array of light sources or lasers 1403 coupled to plurality of optical modulators 1410 (“optical modulators 1410”), which provide optical signal inputs to optical matrix multiplier 1405 integrated in silicon substrate 1401. PIC 1400 also includes non-linear (NL) optical devices 1406 and photodetectors 1407. In the embodiment, PIC 1400 is disposed on a redistribution layer 1441 (redistribution layer 1441 includes, e.g., a silicon substrate, silicon interposer, or the like) which is connected via connectors 1438 to pads 1442 and vias 1432 of silicon interposer 1433. Note that only one connector, pad, and via, may be labeled in the FIG. for clarity. As shown, single integrated EIC 1418 is disposed on package substrate 1435.

Note that in embodiments, input data from CPU and SRAM combination 1456 follows a path 1412 downward through a silicon interposer 1433 to single integrated EIC die 1418 and then upwards to PIC 1400. In the embodiment, single integrated EIC die 1418 includes e.g., some or substantially all functions of electronic support circuitry 1150 of FIG. 11. In embodiments, single integrated EIC die 1418 includes DAC circuitry (e.g., to perform functions similar to as described in connection with DAC 1117 and 1125 of FIG. 11), ADC circuitry 1118 (e.g., to perform functions similar to as described in connection with ADC 1118 of FIG. 11), laser and optical modulator drivers and control of (e.g., to perform functions similar to as described in connection with controller 1102 of FIG. 11), control for laser and optical modulator drivers (also to perform functions similar to as described in connection with (PMIC) controller 1102 of FIG. 11), CPU control circuitry, memory (e.g., SRAM 1167 of FIG. 11) for weights and other functions not performed by CPU and SRAM combination 1456.

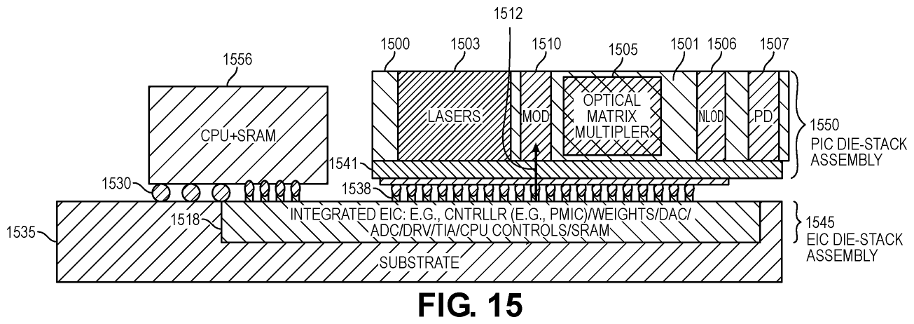

Referring now to FIG. 15 which is a side view of another embodiment of a PIC and a CPU vertically stacked over a single integrated EIC. The configuration is similar to that of FIG. 14, where a CPU (e.g. CPU and SRAM combination) is included on a same substrate as PIC 1500. In contrast, however, to FIG. 14, single integrated EIC 1518, rather than sitting above a package substrate, is integrated into a package substrate 1535. Similar to FIGS. 13 and 14, in embodiments, single integrated EIC 1518 integrates some or substantially all elements of electronic circuitry, e.g., electronic circuitry 1150 of FIG. 11. In the embodiment of FIG. 15, PIC 1500 is a single flip-chip PIC (see PIC die-stack assembly 1550) on a redistribution layer 1541 that is disposed on package substrate 1535 that integrates single integrated EIC 1518 of single EIC die-stack assembly 1550. As shown in the FIG., a CPU and SRAM combination 1556 is located on a common substrate 1535 with PIC 1400. In embodiments, the CPU is a CPU with functions similar to CPU 1155 of FIG. 11.

Note that in some embodiments, input data from CPU and SRAM combination 1556 follow a path 1512 to single integrated EIC die 1518 and then to PIC 1500. In the embodiment single integrated EIC die 1518 includes e.g., some or substantially all functions of electronic circuitry 1150 of FIG. 11. In embodiments, single integrated EIC die 1518 includes DAC circuitry (e.g., to perform functions similar to as described in connection with DAC 1117 and 1125 of FIG. 11), ADC circuitry (e.g., to perform functions similar to as described in connection with ADC 1118 of FIG. 11), laser and optical modulator drivers (e.g., to perform functions similar to as described in connection with controller 1102 or ADC 1118 and DAC 1117, 1125 of FIG. 11), control for laser and optical modulator drivers (also to perform functions similar to as described in connection with controller 1102 or ADC 1118 and DAC 1117, 1125 of FIG. 11), CPU control circuitry, and memory (e.g., SRAM 1167 of FIG. 11 for weights and other functions not performed by CPU and SRAM combination 1556).

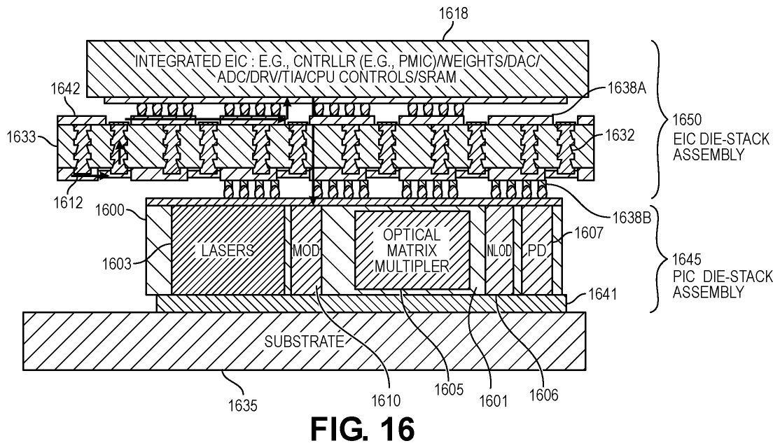

Referring now to FIG. 16 which is a side view of an embodiment including a single integrated EIC 1618 stacked over a PIC 1600 (similar to PIC 1100 of FIG. 11). Similar to previous FIGS. 13-15, in embodiments, single integrated EIC 1618 integrates some or substantially all elements of electronic support circuitry, e.g., electronic support circuitry 1150 of FIG. 11. In the embodiment of FIG. 16, PIC 1600 is a single flip-chip PIC of a PIC die-stack assembly 1650. In the embodiment, PIC 1600 is disposed on a redistribution layer 1641 disposed toward a bottom of an IC optical accelerator package on substrate 1635.

Note that PIC 1600 includes the same or similar elements as PIC 1100, e.g. an array of light sources or lasers 1603 coupled to plurality of optical modulators 1610 (“optical modulators 1610”), which provide optical signal inputs to an optical matrix multiplier 1605 integrated in silicon substrate 1601. PIC 1600 also includes non-linear (NL) optical devices and photodetectors 1607. In the embodiment, single integrated EIC 1618 is connected via connectors 1638A to pads 1642 and vias 1632 of silicon interposer 1633. Note that only one connector, pad, and via, may be labeled in the FIG. for clarity. As shown, single integrated EIC 1618 is located at a top of the configuration and thus may allow easier access to pins of EIC 1618 as well as thermal advantages for EIC 1618.

Note that in embodiments, input data from a CPU (e.g. CPU 1155 of FIG. 11) follows a path 1612 upwards through silicon interposer 1633 to single integrated EIC die 1618 and then downwards to PIC 1600. In the embodiment single integrated EIC die 1618 includes e.g., some or substantially all functions of electronic support circuitry 1150 of FIG. 11. For example, in embodiments, single integrated EIC die 1618 includes DAC circuitry (e.g., to perform functions similar to as described in connection with DAC 1117 and 1125 of FIG. 11), ADC circuitry (e.g., to perform functions similar to as described in connection with ADC 1118 of FIG. 11), laser and optical modulator drivers (e.g., to perform functions similar to as described in connection with controller 1102 or ADC 1118 and DAC 1117, 1125 of FIG. 11), control for laser and optical modulator drivers (to perform functions similar to as described in connection with (PMIC) controller 1102 or ADC 1118 and DAC 1117, 1125 of FIG. 11), CPU control circuitry, and memory (e.g., SRAM 1167 of FIG. 11 to store weights, etc.).

Note that the configuration of the plurality of single integrated EIC die in relation to the PICS and/or a CPU/SRAM combination shown in FIGS. 13-16 are merely examples. In various embodiments, any suitable combination or configuration (e.g., vertically stacked or side-by-side) of the single integrated EIC die, PIC, and/or a CPU/SRAM that facilitates pre- and post-processing of optical signal inputs and optical signal outputs are contemplated. Furthermore, the included functions of the single integrated EIC dies may include other functions not discussed herein but that also assist in the pre-and post-processing of the optical signal inputs and optical signal outputs. In addition, the input data paths are merely examples and it is understood that paths for input data and output data from and between the single integrated EIC die and the PIC will vary. In embodiments, the paths provide radiofrequency (RF) and DC interfaces between the PIC, EIC and/or CPU/SRAM within a single optical accelerator package that offers higher efficiency and speed relative to separate configurations. In embodiments, a relatively smaller size of the PIC that includes the matrix multipliers of FIGS. 1-9 allows integration into a single package with the EIC configurations shown herein. Integration of the EIC into the optical accelerator package as described in FIGS. 12-16 as described above may provide higher bandwidth, higher density and lower power consumption due to a proximal location of radiofrequency (RF) interfaces of the PIC and EIC.

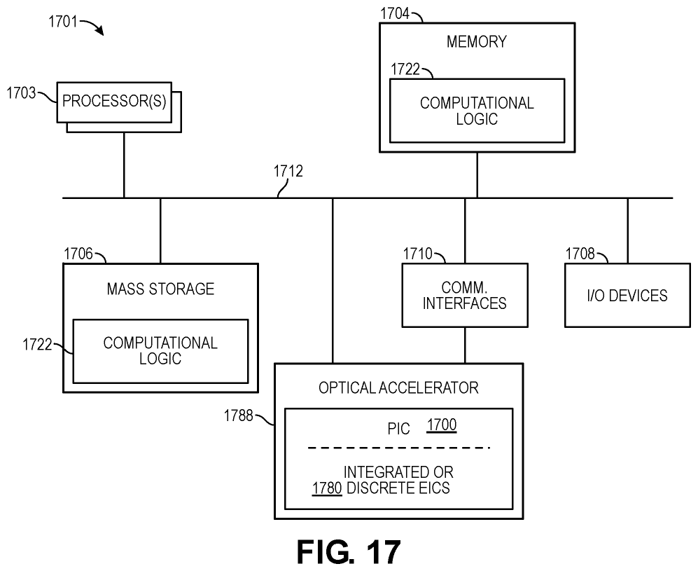

FIG. 17 illustrates an example computing device 1701 suitable for use with an integrated photonics device or PIC 1700 (e.g., similar to or the same as PICS 1100-1600 of respective FIGS. 11-16), in accordance with various embodiments as described herein. In embodiments, PIC 1700 includes an optical neural network (ONN) integrated circuit (IC) including an array of light sources and an optical matrix multiplier in a semiconductor substrate. In embodiments, the array of light sources generates an array of light signals and PIC 1700 further includes an integrated plurality of optical modulators to receive the array of light signals and modulate data onto the array of light signals and provide optical signal inputs to the optical matrix multiplier. In embodiments, the optical matrix multiplier linearly transforms the plurality of optical signal inputs into an array of optical signal outputs. In embodiments, a processor coupled to the PIC provides the PIC with the data to modulate onto the array of optical signal inputs to be transformed by the optical matrix multiplier.

For example, as shown, computing device 1701 may include a one or more processors or processor cores 1703 and memory 1704. In embodiments, memory 1704 may be system memory. For the purpose of this application, including the claims, the terms “processor” and “processor cores” may be considered synonymous, unless the context clearly requires otherwise. The processor 1703 may include any type of processors, such as a central processing unit CPU, a microprocessor, and the like. The processor 1703 may be implemented as an integrated circuit having multi-cores, e.g., a multi-core microprocessor. The computing device 1701 may include mass storage devices 1706 (such as diskette, hard drive, volatile memory (e.g., dynamic random-access memory (DRAM), compact disc read-only memory (CD-ROM), digital versatile disk (DVD), and so forth). In general, memory 1704 and/or mass storage devices 1706 may be temporal and/or persistent storage of any type, including, but not limited to, volatile and non-volatile memory, optical, magnetic, and/or solid state mass storage, and so forth. Volatile memory may include, but is not limited to, static and/or dynamic random-access memory. Non-volatile memory may include, but is not limited to, electrically erasable programmable read-only memory, phase change memory, resistive memory, and so forth. In embodiments, processor 1703 is a high performance or server CPU (e.g., CPU 1155). In some embodiments, optical accelerator 1788 includes an IC optical accelerator package that also includes processor 1703 or CPU 1155 (e.g., FIGS. 14 and 15).

The computing device 1701 may further include input/output (I/O) devices 1708 (such as a display (e.g., a touchscreen display), keyboard, cursor control, remote control, gaming controller, image capture device, and so forth) and communication interfaces 1710 (such as network interface cards, modems, infrared receivers, radio receivers (e.g., Bluetooth), and so forth). In some embodiments, the communication interfaces 1710 may include or otherwise be coupled with integrated photonics device 1701, as described above, in accordance with various embodiments.

The communication interfaces 1710 may include communication chips that may be configured to operate the device 1700 in accordance with a Global System for Mobile Communication (GSM), General Packet Radio Service (GPRS), Universal Mobile Telecommunications System (UMTS), High Speed Packet Access (HSPA), Evolved HSPA (E-HSPA), or Long-Term Evolution (LTE) network. The communication chips may also be configured to operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chips may be configured to operate in accordance with Code Division Multiple Access (CDMA), Time Division Multiple Access (TDMA), Digital Enhanced Cordless Telecommunications (DECT), Evolution-Data Optimized (EV-DO), derivatives thereof, as well as any other wireless protocols that are designated as 3G, 4G, 5G, and beyond. The communication interfaces 1710 may operate in accordance with other wireless protocols in other embodiments.

The above-described computing device 1701 elements may be coupled to each other via system bus 1712, which may represent one or more buses. In the case of multiple buses, they may be bridged by one or more bus bridges (not shown). Each of these elements may perform its conventional functions known in the art. In particular, memory 1704 and mass storage devices 1706 may be employed to store a working copy and a permanent copy of the programming instructions for the operation of PIC 1700 and integrated or discrete EICs 1780. The various elements may be implemented by assembler instructions supported by processor(s) 1703 or high-level languages that may be compiled into such instructions.

The permanent copy of the programming instructions may be placed into mass storage devices 1706 in the factory, or in the field, through, for example, a distribution medium (not shown), such as a compact disc (CD), or through communication interface 1710 (from a distribution server (not shown)). That is, one or more distribution media having an implementation of the agent program may be employed to distribute the agent and to program various computing devices.

The number, capability, and/or capacity of the elements 1708, 1710, 1712 may vary, depending on whether computing device 1701 is used as a stationary computing device, such as a server computer in a data center, or a mobile computing device, such as a tablet computing device, laptop computer, game console, or smartphone. Their constitutions are otherwise known, and accordingly will not be further described.

For one embodiment, at least one of processors 1703 may be packaged together with computational logic 1722 configured to practice aspects of optical signal transmission and receipt described herein to form a System in Package (SiP) or a System on Chip (SoC).

In various implementations, the computing device 1701 may comprise one or more components of a data center, a laptop, a netbook, a notebook, an ultrabook, a smartphone, a tablet, a personal digital assistant (PDA), an ultra mobile PC, a mobile phone, or a digital camera. In further implementations, the computing device 1701 may be any other electronic device that processes data.

According to various embodiments, the present disclosure describes a number of examples.

Example 1 includes an optical accelerator package, comprising a photonics integrated circuit (PIC), wherein the PIC includes an optical matrix multiplier to transform an array of optical signal inputs into an array of optical signal outputs; and an electronics integrated circuit (EIC) coupled to the PIC, wherein the EIC is heterogeneously integrated into the optical accelerator package in a manner to proximally provide pre- and post-processing of the optical signal inputs and the optical signal outputs provided to and received from the optical matrix multiplier of the PIC.

Example 2 includes the optical accelerator package of Example 1, wherein the EIC is stacked vertically above or below the PIC and the PIC includes the optical matrix multiplier and an array of light sources and an array of optical modulators integrated in the single semiconductor substrate.

Example 3 includes the optical accelerator package of Example 2, wherein the optical matrix multiplier comprises a plurality of 2×2 unitary optical matrices optically interconnected, wherein each 2×2 unitary optical matrix comprises a plurality of phase shifters to phase shift, split, or combine one or more of the optical signal inputs.

Example 4 includes the optical accelerator package of Example 1, wherein the optical signal inputs and the optical signal outputs provided to and received from the optical matrix multiplier unit include data provided to and received from a server central processing unit (CPU) coupled to the optical accelerator package.

Example 5 includes the optical accelerator package of Example 1, wherein the pre- and post-processing of the optical signal inputs and the optical signal outputs includes electro-optical and opto-electrical conversion of data provided to and received from the PIC.

Example 6 includes the optical accelerator package of Example 1, wherein the EIC further comprises drivers for a plurality of lasers and optical modulators included in the PIC and a controller to control the drivers.

Example 7 includes the optical accelerator package of Example 1, wherein the EIC further includes an SRAM memory to store a plurality of weights to be provided to the optical unitary matrix multiplier unit.

Example 8 includes the optical accelerator package of Example 1, wherein the EIC further includes control circuitry to implement control from the server central processing unit (CPU).

Example 10 includes the optical accelerator package of Example 1, wherein the EIC includes at least one of an analog to digital converter (ADC), digital to analog converter (DAC), laser driver, optical modulator driver, transimpedance amplifier (TIA), performance management integrated circuit (PMIC), central processing unit (CPU) controller circuitry, storage or pipeline for weights, and SRAM memory.

Example 11 includes an optical accelerator package, comprising: a photonics integrated circuit (PIC) die, wherein the PIC includes an optical matrix multiplier to transform an array of optical signal inputs into an array of optical signal outputs; and a plurality of discrete electronics integrated circuit (EIC) dies coupled to the PIC, wherein the plurality of EIC dies are stacked in a manner vertically above or below the PIC to proximally provide pre- and post-processing of the optical signal inputs and the optical signal outputs provided to and received from the optical matrix multiplier of the PIC.

Example 12 includes the optical accelerator package of Example 11, wherein the PIC is included on a single semiconductor substrate and includes the optical matrix multiplier and an array of light sources and an array of optical modulators and an array of photodetectors integrated in the single semiconductor substrate, wherein the PIC is optically self-contained without a need to connect optically with other photonics dies or optical assemblies

Example 13 includes the optical accelerator package of Example 11, wherein the plurality of discrete electronics integrated circuit (EIC) dies comprise discrete dies to provide one or more of analog-to-digital converter (ADC) functions, digital-to-analog converter (DAC) functions, TIA, performance management integrated circuit (PMIC), driver and driver control functions for optical modulators lasers, memory, and CPU control circuitry functions.

Example 14 includes the optical accelerator package of Example 11, wherein the optical signal inputs and the optical signal outputs provided to and received from the optical matrix multiplier unit include data provided to and received from a server central processing unit (CPU) coupled to the optical accelerator package.

Example 15 includes the optical accelerator package of Example 12, wherein the PIC and the EIC comprise a co-processor for the server CPU.

Example 16 includes a system for implementing an optical neural network (ONN), comprising: an optical accelerator package, including a photonics integrated circuit (PIC) die, wherein the PIC die includes an optical matrix multiplier to transform an array of optical signal inputs into an array of optical signal outputs; and an electronics integrated circuit (EIC) die coupled to the PIC die, wherein the EIC die is stacked in a manner vertically above or below the PIC die to proximally provide pre- and post-processing of the optical signal inputs and the optical signal outputs provided to and received from the optical matrix multiplier of the PIC die; and a central processing unit (CPU) coupled the optical accelerator package to provide the data to and from the optical accelerator package to be converted into the optical signal inputs and the optical signal outputs.

Example 17 includes the system of Example 16, wherein the EIC includes at least two of an analog to digital converter (ADC), digital to analog converter (DAC), laser drivers, optical modulator drivers, controller circuitry, and SRAM memory.

Example 18 includes the system of Example 16, wherein the EIC die provides substantially all functions required for pre-and post-processing of analog data provided between the PIC die and the CPU including optical-to-electrical and electrical-to-optical transduction.

Example 19 includes the system of Example 16, wherein the PIC includes the optical matrix multiplier, an array of light sources, and an array of optical modulators integrated in the single semiconductor substrate.

Example 20 includes the optical accelerator package of any one of Examples 16-19, wherein the optical matrix multiplier comprises a plurality of 2×2 unitary optical matrices optically interconnected, wherein each 2×2 unitary optical matrix comprises a plurality of phase shifters to phase shift, split, or combine one or more of the optical signal inputs.

Various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

The above description of illustrated implementations, including what is described in the Abstract, is not intended to be exhaustive or to limit the embodiments of the present disclosure to the precise forms disclosed. While specific implementations and examples are described herein for illustrative purposes, various equivalent modifications are possible within the scope of the present disclosure, as those skilled in the relevant art will recognize.

These modifications may be made to embodiments of the present disclosure in light of the above detailed description. The terms used in the following claims should not be construed to limit various embodiments of the present disclosure to the specific implementations disclosed in the specification and the claims. Rather, the scope is to be determined entirely by the following claims, which are to be construed in accordance with established doctrines of claim interpretation.

What is claimed is:

1. An optical accelerator package, comprising:
a photonics integrated circuit (PIC), wherein the PIC includes an optical matrix multiplier to transform an array of optical signal inputs into an array of optical signal outputs; and
an electronics integrated circuit (EIC) coupled to the PIC, wherein the EIC is heterogeneously integrated into the optical accelerator package in a manner to proximally provide pre- and post-processing of the optical signal inputs and the optical signal outputs provided to and received from the optical matrix multiplier of the PIC.

2. The optical accelerator package of claim 1, wherein the EIC is stacked vertically above or below the PIC and the PIC includes the optical matrix multiplier and an array of light sources and an array of optical modulators integrated in the single semiconductor substrate.

3. The optical accelerator package of claim 2, wherein the optical matrix multiplier comprises a plurality of 2×2 unitary optical matrices optically interconnected, wherein each 2×2 unitary optical matrix comprises a plurality of phase shifters to phase shift, split, or combine one or more of the optical signal inputs.

4. The optical accelerator package of claim 1, wherein the optical signal inputs and the optical signal outputs provided to and received from the optical matrix multiplier unit include data provided to and received from a server central processing unit (CPU) coupled to the optical accelerator package.

5. The optical accelerator package of claim 1, wherein the pre- and post-processing of the optical signal inputs and the optical signal outputs includes electro-optical and opto-electrical conversion of data provided to and received from the PIC.

6. The optical accelerator package of claim 1, wherein the EIC further comprises drivers for a plurality of lasers and optical modulators included in the PIC and a controller to control the drivers.

7. The optical accelerator package of claim 1, wherein the EIC further includes an SRAM memory to store a plurality of weights to be provided to the optical unitary matrix multiplier unit.

8. The optical accelerator package of claim 1, wherein the EIC further includes control circuitry to implement control from the server central processing unit (CPU).

9. The optical accelerator package of claim 1, wherein the EIC includes at least a combination of two of an analog to digital converter (ADC), digital to analog converter (DAC), laser drivers, optical modulator drivers, controller circuitry, and SRAM memory

10. The optical accelerator package of claim 1, wherein the EIC includes at least one of an analog to digital converter (ADC), digital to analog converter (DAC), laser driver, optical modulator driver, transimpedance amplifier (TIA), performance management integrated circuit (PMIC), central processing unit (CPU) controller circuitry, storage or pipeline for weights, and SRAM memory.

11. An optical accelerator package, comprising:
a photonics integrated circuit (PIC) die, wherein the PIC includes an optical matrix multiplier to transform an array of optical signal inputs into an array of optical signal outputs; and
a plurality of discrete electronics integrated circuit (EIC) dies coupled to the PIC, wherein the plurality of EIC dies are stacked in a manner vertically above or below the PIC to proximally provide pre- and post-processing of the optical signal inputs and the optical signal outputs provided to and received from the optical matrix multiplier of the PIC.

12. The optical accelerator package of claim 11, wherein the PIC is included on a single semiconductor substrate and includes the optical matrix multiplier and an array of light sources and an array of optical modulators and an array of photodetectors integrated in the single semiconductor substrate, wherein the PIC is optically self-contained without a need to connect optically with other photonics dies or optical assemblies.

13. The optical accelerator package of claim 11, wherein the plurality of discrete electronics integrated circuit (EIC) dies comprise discrete dies to provide one or more of analog-to-digital converter (ADC) functions, digital-to-analog converter (DAC) functions, TIA, performance management integrated circuit (PMIC), driver and driver control functions for optical modulators lasers, memory, and CPU control circuitry functions.

14. The optical accelerator package of claim 11, wherein the optical signal inputs and the optical signal outputs provided to and received from the optical matrix multiplier unit include data provided to and received from a server central processing unit (CPU) coupled to the optical accelerator package.

15. The optical accelerator package of claim 12, wherein the PIC and the EIC comprise a co-processor for the server CPU.

16. A system for implementing an optical neural network (ONN), comprising:
an optical accelerator package, including:
a photonics integrated circuit (PIC) die, wherein the PIC die includes an optical matrix multiplier to transform an array of optical signal inputs into an array of optical signal outputs; and
an electronics integrated circuit (EIC) die coupled to the PIC die, wherein the EIC die is stacked in a manner vertically above or below the PIC die to proximally provide pre- and post-processing of the optical signal inputs and the optical signal outputs provided to and received from the optical matrix multiplier of the PIC die; and
a central processing unit (CPU) coupled the optical accelerator package to provide the data to and from the optical accelerator package to be converted into the optical signal inputs and the optical signal outputs.

17. The system of claim 16, wherein the EIC includes at least a combination of two of an analog to digital converter (ADC), digital to analog converter (DAC), laser drivers, optical modulator drivers, controller circuitry, and SRAM memory.

18. The system of claim 16, wherein the EIC die provides substantially all functions required for pre-and post-processing of analog data provided between the PIC die and the CPU including optical-to-electrical and electrical-to-optical transduction.

19. The system of claim 16, wherein the PIC includes the optical matrix multiplier, an array of light sources, and an array of optical modulators integrated in the single semiconductor substrate.

20. The system of claim 19, wherein the optical matrix multiplier comprises a plurality of 2×2 unitary optical matrices optically interconnected, wherein each 2×2 unitary optical matrix comprises a plurality of phase shifters to phase shift, split, or combine one or more of the optical signal inputs.
